(19) United States
(12) Patent Application Publication
(10) Pub. No.: US 2010/0128039 A1
(43) Pub. Date: May 27, 2010

(54) IMAGE DATA PROCESSING METHOD, IMAGE SENSOR, AND INTEGRATED CIRCUIT

(76) Inventors: Kwang-Jun CHO, Gyeonggi-do (KR); Young-Chul Sohn, Gyeonggi-do (KR)

Correspondence Address: IP & T Law Firm PLC, 7700 Little River Turnpike, Suite 207, Annandale, VA, 22003, US

(21) Appl. No.: 12/344,965

(22) Filed: Dec. 29, 2008

(30) Foreign Application Priority Data
Nov. 26, 2008 (KR) 10-2008-0118000

(51) Int. Cl. G06T 1/00

(52) U.S. Cl. 345/428

(57) ABSTRACT

An image data processing method includes obtaining pixel data from a pixel array and generating image data by rearranging the pixel data.

### CROSS-REFERENCE TO RELATED APPLICATIONS

The present invention claims priority of Korean patent application number 10-2008-0118000, filed on Nov. 26, 2008, which is incorporated by reference in its entirety.

### BACKGROUND OF THE INVENTION

The present invention relates to an image sensing device such as a charged coupled device (CCD) and a CMOS image sensor (CIS), and more particularly, to a device and method for processing a color image data signal.

In general, color interpolation is performed by demosaicking data outputted from a pixel array so as to achieve the maximum resolution in a CCD or CIS.

FIG. 1 is a flowchart illustrating a conventional image data processing method. Referring to FIG. 1, the conventional image data processing method includes an operation S100 of obtaining pixel data from a pixel array, an operation S120 of generating image data by performing a color interpolation through demosaicking the pixel data, and an operation S140 of scaling the generated image data.

The operation S100 of obtaining the pixel data includes an operation S102 of converting an analog signal, e.g., R, G and B signals, outputted from the pixel array into a digital signal. The operation S120 of generating the image data RGB (M×N) by the color interpolation is performed by receiving the digital signal. In the operation S140 of scaling the image data, which is performed to adjust the resolution, the input data RGB (M×N) are scaled down to lower-resolution data RGB (M/2×N/2). Alternatively, the image data RGB (M×N) may be scaled up to higher-resolution data.

FIG. 2 illustrates a color filter array of a Bayer pattern. As illustrated in FIG. 2, when a plurality of pixels are arranged in M×N matrix form where M number of pixels are arranged in each column and N number of pixels are arranged in each row, green (G), blue (B) and red (R) color filters are positioned in correspondence to the respective pixels. The Bayer pattern includes a plurality of unit patterns 200 arranged in rows and columns, each of which is configured with one red filter, two green filters, and one blue filter.

FIG. 3 illustrates a conventional color interpolation method.

Referring to FIG. 3, pixel data of a Bayer RGB pattern 310 are separated into same-colored pixel data groups. That is, the Bayer RGB pattern 310 is divided into a red color filter plane 320a, a green color filter plane 320b, and a blue color filter plane 320c.

Data are also assigned to empty pixels in each color filter plane. That is, image layer data are generated through demosaicking operation by other peripheral signals. Patterns having the image layer data are respectively shown as red, green and blue image layer patterns 330a, 330b and 330c in FIG. 3.

Afterwards, red, green and blue image data corresponding to the red, green and blue image layer patterns 330a, 330b and 330c are merged. This merging procedure is indicated by reference numeral 340 in FIG. 3.

As described above, the conventional image sensor realizes the maximum resolution image from the pixel data using the color interpolation method of FIG. 3.

However, the color interpolation is a method of adding virtual data using the measured data, and thus brings about a decrease in image quality after all.

### SUMMARY OF THE INVENTION

Some embodiments of the present invention are directed to provide an image data processing method for obtaining an image with improved quality by generating image data using actual data of pixels while not using or minimally using a data interpolation process.

Some embodiments of the present invention are directed to provide an image sensor and an integrated circuit for performing an image data processing.

In accordance with an aspect of the present invention, there is provided an image data processing method, including: obtaining pixel data from a pixel array; and generating image data by rearranging the pixel data. The image data processing method may further include scaling the generated image data to adjust resolution.

The generation of the image data may include: generating a plurality of image layer data by rearranging only same-colored pixel data among the pixel data obtained from the pixel array; and merging the plurality of image layer data. The generation of the image layer data may be performed by rearranging only actual data of pixels without interpolation. The generation of the image layer data may includes: sampling some of the same-colored pixel data; and rearranging the sampled data. The pixel number of the image layer data may be a quarter of a total number of pixels of the pixel array. The obtaining of the pixel data may include converting an analog signal outputted from the pixel array into a digital signal.

In accordance with another aspect of the present invention, there is provided an image sensor, including: a pixel array comprising a color filter array; and a data processor configured to generate image data by receiving pixel data from the pixel array and rearranging the pixel data. The image processor may further include a scaling unit configured to scale the image data to adjust resolution, and it may include a means for converting an analog signal outputted from the pixel array into a digital signal.

The data processor may generate a plurality of image layer data by rearranging only same-colored pixel data among the pixel data obtained from the pixel array, and generate the image data by merging the plurality of image layer data. Also, the data processor may generate the image data by rearranging the actual data of the pixel data without interpolation. Also, the data processor may sample only part of the pixel data corresponding to the same color and generate the image data by rearranging the sampled data. In addition, the data processor may generate the image data corresponding to the pixel number of the image layer data, for example, a quarter of a total number of pixels of the pixel array.

### BRIEF DESCRIPTION OF THE DRAWINGS

FIG. 1 is a flowchart illustrating a conventional image data processing method.

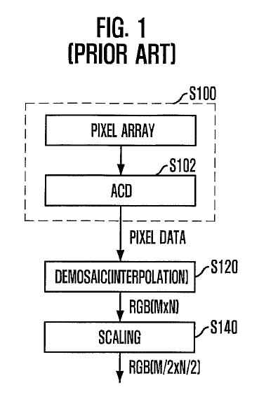

FIG. 2 illustrates a color filter array of a Bayer pattern.

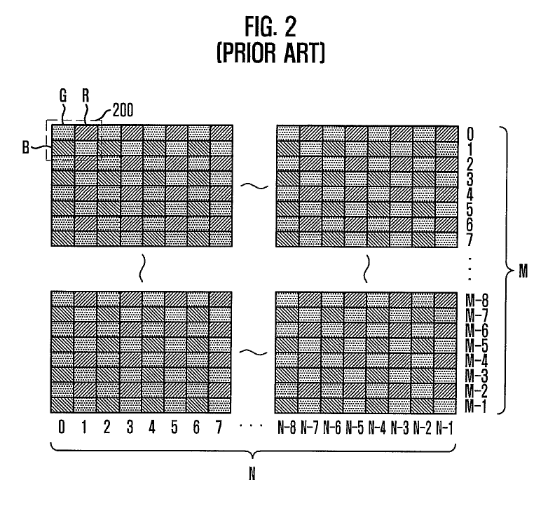

FIG. 3 illustrates a conventional color interpolation method.

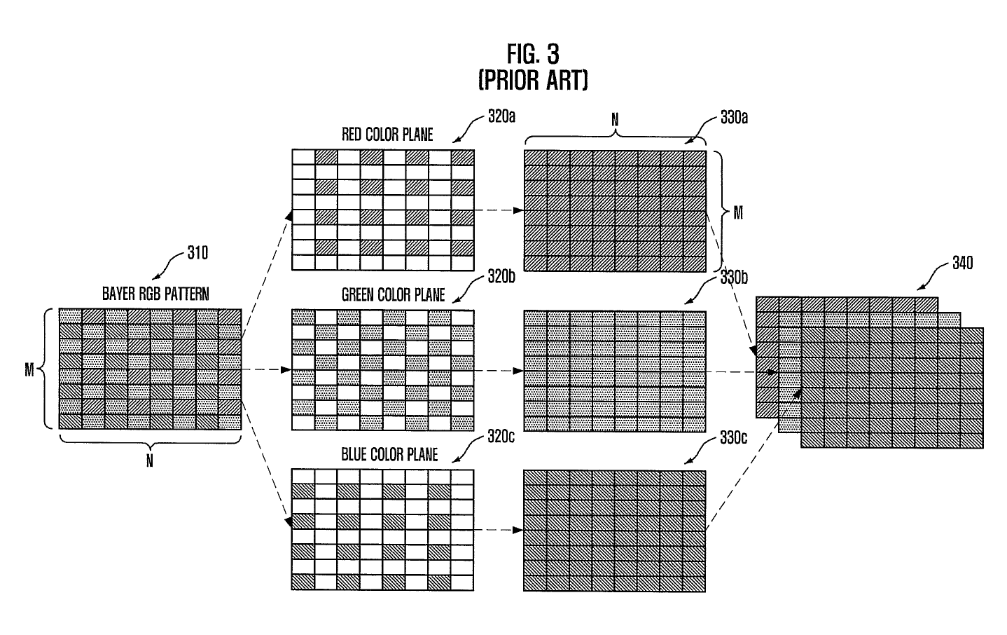

FIG. 4 is a flowchart illustrating an image data processing method in accordance with a preferred embodiment of the present invention.

FIG. 5 illustrates a data rearrangement method on a pixel array having a Bayer RGB pattern.

FIG. 6 illustrates a data rearrangement method on a pixel array having a RGBW pattern.

FIG. 7 is a block diagram of an image sensor in accordance with a preferred embodiment of the present invention.

### DESCRIPTION OF SPECIFIC EMBODIMENTS

Other objects and advantages of the present invention can be understood by the following description, and become apparent with reference to the embodiments of the present invention.

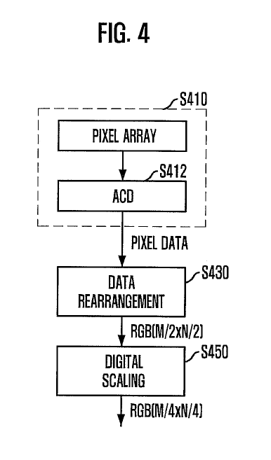

FIG. 4 is a flowchart illustrating an image data processing method in accordance with a preferred embodiment of the present invention.

Referring to FIG. 4, the image data processing method in accordance with this embodiment includes an operation S410 of obtaining pixel data from a pixel array, and an operation S430 of generating image data by rearranging the pixel data. The image data processing method in accordance with this embodiment may further include an operation S450 of scaling the generated image data so as to adjust the resolution.

The operation S410 of obtaining the pixel data includes an operation S412 of converting analog signals, e.g., red (R), green (G) and blue (B) signals, outputted from the pixel array into digital signals. The operation S430 of generating image data RGB (M/2×N/2) (for example, a quarter of the output data of the pixel array) by rearranging the pixel data is performed after receiving the converted digital signal. In the scaling operation S450 that is performed to adjust the resolution, the input data RGB (M/2×N/2) is scaled down to lower-resolution data RGB (M/4×N/4). Alternatively, in the scaling operation S450, the input data RGB (M/2×N/2) may be scaled up to higher-resolution data, for example, RGB (M×N).

In this way, in the image data processing method in accordance with the present invention, the image data may be generated by rearranging actual pixel data while not performing a color interpolation on the pixel data through demosaicking or minimally performing the color interpolation.

Therefore, it is possible to obtain an image signal with improved image quality because a method of adding virtual data is not used or minimally used.

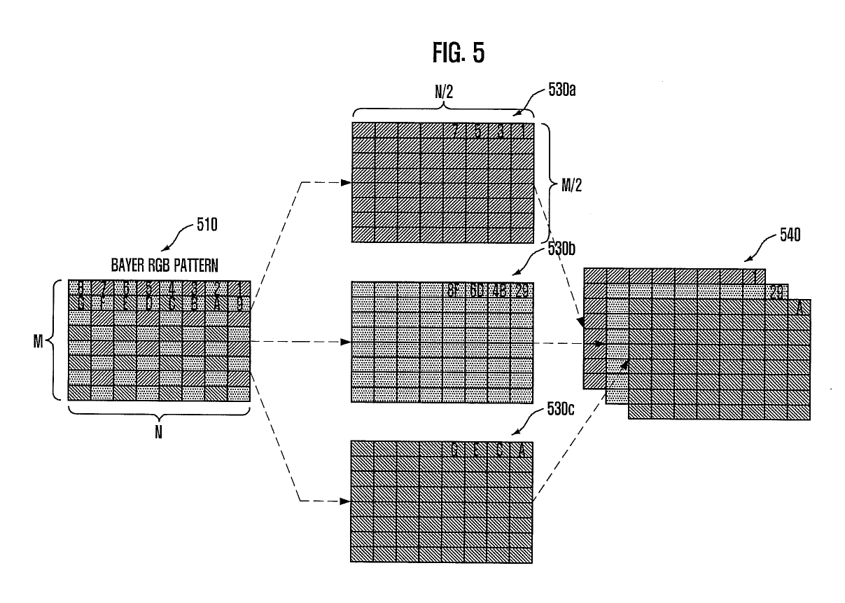

FIG. 5 illustrates a data rearrangement method that corresponds to the operation S430 of generating the image data as illustrated in FIG. 4. To be specific, FIG. 5 illustrates a data rearrangement method on a pixel array having a Bayer RGB pattern.

Referring to FIG. 5, image layer data are generated by rearranging pixel data of a Bayer RGB pattern 510 into same-colored pixel data. That is, red image layer data are generated by rearranging only red pixel data, blue image layer data are generated by rearranging only blue pixel data, and green image layer data are generated by averaging values of two adjacent green pixel data through color interpolation. Patterns corresponding to the red, green and blue image layer data are respectively shown as red, green and blue image layer patterns 530a, 530b and 530c in FIG. 5. Since the Bayer pattern includes a plurality unit patterns each of which is configured with one red filter, two green filters and one blue filter, number of pixels in each of the red, green and blue image layer patterns 530a, 530b and 530c is equal to a quarter of a total number of pixels in the original pixel array. That is, the pixel data RGB (M×N) is changed into the image layer data RGB (M/2×N/2). Meanwhile, the green image layer pattern 530b is generated by interpolating values of two adjacent green pixels in the unit pattern. Positions of the rearranged pixels are represented by reference numerals and alphabets in FIG. 5.

Thereafter, the red, green and blue image layer data corresponding to the red, green and blue image layer patterns 530a, 530b and 530c are merged. In FIG. 5, such a merging procedure is indicated by a reference numeral 540.

As described above, the data processing of the red and blue image data by the rearrangement is realized by rearranging only actual data without color interpolation. However, the green image data are generated through demosaicking operation. Therefore, it is possible to obtain image data on which the color interpolation process is minimally performed, thus realizing improved image quality in comparison with the conventional image data processing method.

During the rearrangement of the pixel data, only some of the same-colored pixel data are sampled, and the image layer data may be generated by rearranging the sampled data. That is, the pixel data RGB (M×N) is changed into image data having the resolution lower than the image data RGB (M/2×N/2). However, as illustrated in FIG. 5, the data rearrangement makes the resolution of the image data to be half the resolution of the pixel data so that it may be unnecessary to perform a sub sampling operation. If necessary, the data may be scaled down during the follow-on scaling operation S450.

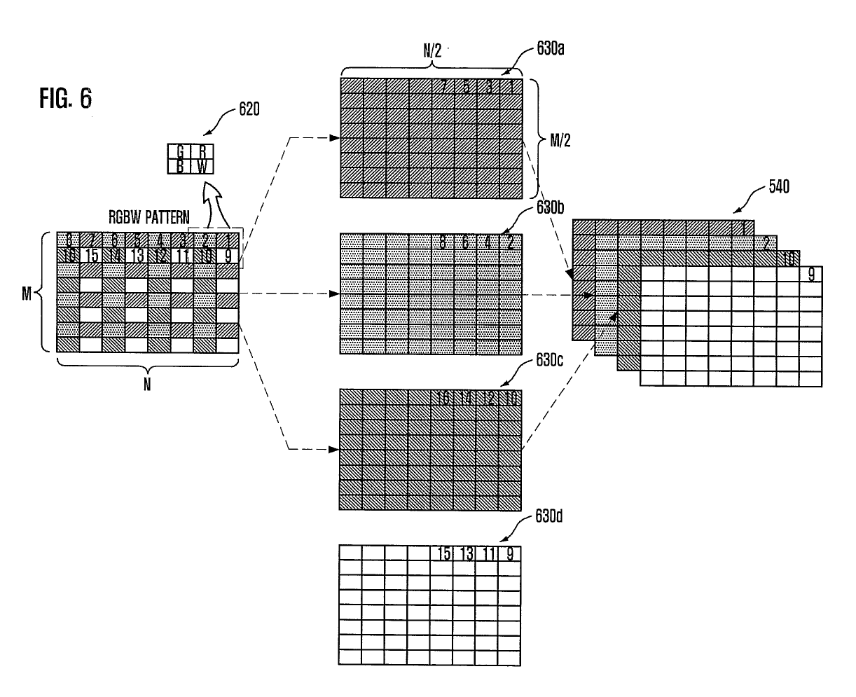

FIG. 6 illustrates a method for generating image data by rearranging pixel data obtained from a pixel array including red pixels, green pixels, blue pixels and white pixels.

Referring to FIG. 6, an RGBW pattern includes a plurality of unit patterns 620 each of which is configured with one red pixel, one green pixel, one blue pixel and one white pixel.

Image layer data is generated by rearranging only pixel data of the RGBW pattern 610 into same-colored pixel data. That is, red image layer data is generated by rearranging only red pixel data, blue image layer data is generated by rearranging only blue pixel data, green image layer data is generated by rearranging only green pixel data, and white image layer data is generated by rearranging only white pixel data. Patterns corresponding to the red, green, blue and white image layer data are shown as red, green, blue and white image layer patterns 630a, 630b, 630c and 630d in FIG. 6.

Number of pixels in each of the red, green, blue and white image layer patterns 630a, 630b, 630c and 630d is equal to a quarter of the total number of pixels in the original pixel array. That is, the pixel data RGB (M×N) is changed into the image layer data RGB (M/2×N/2). Positions of the rearranged pixels are represented by reference numerals and alphabets in FIG. 6.

The red, green, blue and white image layer data corresponding to the red, green, blue and white image layer patterns 630a, 630b, 630c and 630d are merged. In FIG. 6, such a merging procedure is indicated by reference numeral 640.

In this embodiment, the RGBW image data may be generated through only data rearrangement without color interpolation. Therefore, an image signal with improve image quality may be achieved by avoiding use of a method of adding virtual data.

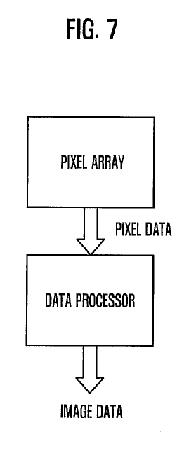

FIG. 7 is a block diagram of an image sensor in accordance with a preferred embodiment of the present invention.

Referring to FIG. 7, the image sensor of the present invention includes a pixel array having a color filter array, and a data processor. The data processor generates image data by receiving pixel data from the pixel array and then rearranging the pixel data.

The data processor generates a plurality of image layer data by rearranging the pixel data into same-colored pixel data, and thereafter, generates the image data by merging the plurality of image layer data.

The data processor may generate the image data by rearranging only actual data of the pixels without color interpolation. Only some of the same-colored pixel data are sampled, and the image data may be generated by rearranging the sampled data.

The data processor generates the image data of which pixel number is smaller than the total number of pixels of the pixel array through the data rearrangement. The image data may have the pixel number that is a quarter of the total number of pixels of the pixel array.

The data processor may include a digital-to-analog converter (DAC) configured to convert an analog signal outputted from the pixel array into a digital signal.

The pixel array may include a Bayer pattern array configured with red pixels, green pixels and blue pixels. The data processor generates red image layer data by rearranging only the red pixel data, generates blue image layer data by rearranging only the blue pixel data, and generates green image layer data by averaging values of two adjacent green pixels through color interpolation. Thereafter, the data processor generates the image data by merging the red, blue and green image layer data.

Alternatively, the pixel array may include a pattern array configured with red pixels, green pixels, blue pixels and white pixels. The image processor generates red image layer data by rearranging only the red pixel data, generates blue image layer data by rearranging only the blue pixel data, generates green image layer data by rearranging only the green pixel data, and generates white image layer data by rearranging only the white pixel data. Afterwards, the data processor generates the image data by merging the red, blue, green and white image layer data.

The data processor may further include a scaling unit configured to scale the image data to adjust the resolution. The scaling unit may be integrated into an image sensor chip. Alternatively, the scaling unit may be provided in a digital signal processor separately fabricated besides the image sensor chip. In this case, it is possible to manufacture an integrated circuit where the image sensor chip and the digital signal processor are integrally formed.

In accordance with the present invention, virtual data is not used or minimally used by generating image data by using only actual data of pixels while not using or minimally using a data interpolation process, thus improving image quality.

While the present invention has been described with respect to the specific embodiments, it will be apparent to those skilled in the art that various changes and modifications may be made without departing from the spirit and scope of the invention as defined in the following claims.

What is claimed is:

1. An image data processing method, comprising:
obtaining pixel data from a pixel array; and
generating image data by rearranging the pixel data.

2. The image data processing method of claim 1, further comprising scaling the generated image data to adjust resolution.

3. The image data processing method of claim 1, wherein generating the image data comprises:
generating each of a plurality of image layer data by rearranging only same-colored pixel data among the pixel data obtained from the pixel array; and
merging the plurality of image layer data into the image data.

4. The image data processing method of claim 3, wherein generating the image layer data is performed by rearranging only actual data of pixels without interpolation.

5. The image data processing method of claim 3, wherein generating the image layer data comprises:
sampling the same-colored pixel data in at least one of the plurality of image layer data; and
rearranging the sampled data.

6. The image data processing method of claim 3, wherein a pixel number of each of the plurality of the image layer data is smaller than a total number of pixels of the pixel array.

7. The image data processing method of claim 5, wherein a pixel number of each of the plurality of the image layer data is a quarter of a total number of pixels of the pixel array.

8. The image data processing method of claim 1, wherein obtaining the pixel data from the pixel array comprises converting an analog signal outputted from the pixel array into a digital signal.

9. The image data processing method of claim 1, wherein the pixel array comprises a Bayer pattern array configured with red (R) pixels, green (G) pixels, and blue (B) pixels.

10. The image data processing method of claim 9, wherein generating the image data comprises:
generating red image layer data by rearranging only the red pixel data;
generating blue image layer data by rearranging only the blue pixel data;
generating green image layer data by averaging values of the two adjacent green pixels through interpolation; and
merging the red image layer data, the blue image layer data and the green image layer data into the image data.

11. The image data processing method of claim 1, wherein the pixel array comprises red pixels, green pixels, blue pixels, and white pixels.

12. The image data processing method of claim 11, wherein generating the image data comprises:
generating red image layer data by rearranging only the red pixel data;
generating blue image layer data by rearranging only the blue pixel data;
generate green image layer data by rearranging only the green pixel data;
generate white image layer data by rearranging only the white pixel data; and
merging the red image layer data, the blue image layer data, the green image layer data, and the white image layer data into the image data.

13. An image sensor, comprising:
a pixel array comprising a color filter array; and
a data processor configured to generate image data by receiving pixel data from the pixel array and rearranging the pixel data.

14. The image sensor of claim 13, wherein the data processor generates each of a plurality of image layer data by rearranging only same-colored pixel data among the pixel data obtained from the pixel array, and generates the image data by merging the plurality of image layer data into the image data.

15. The image sensor of claim 13, wherein the data processor generates the image data by rearranging actual data of pixels without interpolation.

16. The image sensor of claim 14, wherein the data processor samples the same-colored pixel data in at least one of the plurality of image layer data, and rearranges the sampled data to generate the image data.

17. The image sensor of claim 13, wherein the data processor generates the image data of which a pixel number is smaller than a total number of pixels of the pixel array.

18. The image sensor of claim 17, wherein a pixel number of the image data is a quarter of the total number of pixels of the pixel array.

19. The image sensor of claim 13, wherein the data processor comprises a converter configured to convert an analog signal outputted from the pixel array to a digital signal.

20. The image sensor of claim 13, wherein the pixel array comprises a Bayer pattern array configured with red pixels, green pixels, and blue pixels.

21. The image sensor of claim 20, wherein the image processor generates red image layer data by rearranging only the red pixel data, generates blue image layer data by rearranging only the blue pixel data, generates green image layer data by averaging values of the two adjacent green pixels through interpolation, and generates the image data by merging the red image layer data, the blue image layer data, and the green image layer data.

22. The image sensor of claim 13, wherein the pixel array comprises red pixels, green pixels, blue pixels, and white pixels.

23. The image sensor of claim 22, wherein the image processor generates red image layer data by rearranging only the red pixel data, generates blue image layer data by rearranging only the blue pixel data, generates green image layer data by rearranging only the green pixel data, generates white image layer data by rearranging only the white pixel data, and generates the image data by merging the red image layer data, the blue image layer data, the green image layer data, and the white image layer data.

24. The image sensor of claim 13, wherein the image processor further comprises a scaling unit configured to scale the image data to adjust resolution.

25. An integrated circuit, comprising:
an image sensor chip comprising:
a pixel array comprising a color filter array; and
a data processor configured to generate image data by receiving pixel data from the pixel array and rearranging the pixel data; and
a digital signal processor configured to scale the image data outputted from the image sensor chip to adjust resolution.

26. The integrated circuit of claim 25, wherein the data processor generates each of a plurality of image layer data by rearranging only same-colored pixel data among the pixel data obtained from the pixel array, and generates the image data by merging the plurality of image layer data into the image data.

27. The integrated circuit of claim 25, wherein the data processor generates the image data by rearranging actual data of pixels without interpolation.

28. The integrated circuit of claim 25, wherein the pixel array comprises a Bayer pattern array configured with red pixels, green pixels, and blue pixels.
